(19) United States
(12) Patent Application Publication
(10) Pub. No.: US 2026/0258816 A1
(43) Pub. Date: Sep. 3, 2026

(54) CENTRIFUGAL BLOWER, IMPELLER FOR CENTRIFUGAL BLOWER, AND VEHICLE SEAT VENTILATION SYSTEM

(71) Applicant: GENTHERM GMBH, Odelzhausen (DE)

(72) Inventors: Tao Tang, Langfang (CN); Liangbing Hao, Shanghai (CN); Attila Felfoeldi, Nemesvamos (HU); Harsh Harilal Patel, Canton, MI (US)

(21) Appl. No.: 19/163,879

(22) PCT Filed: Mar. 14, 2024
(86) PCT No.: PCT/CN2024/081677

§ 371 Date: Sep. 10, 2025

(30) Foreign Application Priority Data
Mar. 14, 2023 (CN) 202310261959.X

(51) Int. Cl. F04D 29/66; B60N 2/56; F04D 29/28

(52) U.S. Cl. CPC F04D 29/666; B60N 2/5621; F04D 29/281

(57) ABSTRACT

An impeller for a centrifugal blower of a vehicle seat ventilation system that includes: a hub; and a plurality of blades arranged on one side of the hub; a suction surface of the blade is formed with a protruding vortex reducing structure; a corresponding centrifugal blower; and a corresponding vehicle seat ventilation system.

### CROSS REFERENCE TO RELATED APPLICATIONS

This application is a National Stage entry of PCT/CN 2024/081677 filed on Mar. 14, 2024, which claims priority to CN 202310261959.X filed on Mar. 14, 2023, the entireties of which are all hereby incorporated by reference herein for all purposes.

### TECHNICAL FIELD

The present disclosure relates to an impeller for a centrifugal blower of a vehicle seat ventilation system, a corresponding centrifugal blower, and a corresponding vehicle seat ventilation system.

### BACKGROUND ART

With the development of society and the improvement of people's living standards, vehicles have been a part of daily life for many households. When a passenger or a driver is seated in the seat, the back side of the body is in close contact with the seat surface, and there is hardly any air circulation at the contact position, which makes it difficult for sweat to dry and causes an uncomfortable feeling in the human body. The ventilation function effectively improves the air circulation environment of the contact position between the human body and the seat surface, so even after a long time riding in the vehicle, the contact surface between the body and the seat can still remain dry and comfortable. Therefore, now vehicles have been gradually equipped with vehicle seat ventilation systems.

The performance of the blower, as an important part of the vehicle seat ventilation system, is crucial. The working performance of the blower, such as suction performance, is no doubt important, but as the blower is arranged in the cabin of the car, the feeling of the user needs to be considered. For example, the operating noise should be low; otherwise, the sense of quality of the vehicle will be greatly impaired.

In addition, the manufacturing cost of the blower also needs to be taken into consideration, thus, there is a need for coordinative improvement of the manufacture and structure of the blower.

Of course, there may be other issues that need attention in the blower. For this reason, corresponding improvements are required.

In order to overcome one of the aforementioned disadvantages and/or any other possible disadvantages not mentioned here, an object of the present disclosure is to provide an improved impeller for a centrifugal blower of a vehicle seat ventilation system, a corresponding centrifugal blower, and a corresponding vehicle seat ventilation system.

According to a first aspect of the disclosure, an impeller for a centrifugal blower of a vehicle seat ventilation system is provided, comprising: a hub; and a plurality of blades located on one side of the hub, wherein a suction surface of the blade is formed with a protruding vortex reducing structure.

According to an alternative embodiment of the disclosure, the vortex reducing structure is configured to allow to be molded by axial demolding.

According to an alternative embodiment of the disclosure, the blades are configured to allow to be molded by axial demolding.

According to an alternative embodiment of the disclosure, the blades are integrally molded with the hub.

According to an alternative embodiment of the disclosure, the blades are integrally injection molded with the hub.

According to an alternative embodiment of the disclosure, the impeller is configured as a forward impeller.

According to an alternative embodiment of the disclosure, the impeller further comprises a reinforcing ring arranged along outer peripheral edges of the blades on a side away from the hub and connected to the blades.

According to an alternative embodiment of the disclosure, the reinforcing ring is integrally molded with the blades.

According to an alternative embodiment of the disclosure, the vortex reducing structure is arranged adjacent to a front edge of the blade.

According to an alternative embodiment of the disclosure, the vortex reducing structure comprises at least one rib, which extends not in parallel to a direction of extending of the suction surface of the blade from the front edge to a trailing edge of the blade.

According to an alternative embodiment of the disclosure, the at least one rib comprises a plurality of ribs arranged in parallel to and spaced apart from one another so that the vortex reducing structure is wave-like.

According to an alternative embodiment of the disclosure, the rib extends axially.

According to an alternative embodiment of the disclosure, the vortex reducing structure is arranged at least over half a length of the blade.

According to an alternative embodiment of the disclosure, the rib extends across an entire height of the blade.

According to an alternative embodiment of the disclosure, the impeller is configured as a backward impeller.

According to an alternative embodiment of the disclosure, the blade is configured in such a manner that when viewed in an axial direction towards an end face of the hub facing the blade, a profile of a first cross section of the blade axially farther from the end face at least partially exceeds a profile of a second cross section of the blade axially closer to the end face; and the impeller further comprises an annular shroud which is connected, facing the hub, to an edge of the blades.

According to an alternative embodiment of the disclosure, the shroud is integrally injection molded, and the shroud is connected to the edge by welding.

According to a second aspect of the disclosure, a centrifugal blower for a vehicle seat ventilation system is provided, the blower comprising the impeller according to any one of the above embodiments.

According to a third aspect of the disclosure, a vehicle seat ventilation system is provided, the vehicle seat ventilation system comprising the impeller according to any one of the above embodiments or the blower according to any one of the above embodiments.

In a preferred version, the blower has:
a housing, a motor and an impeller, moving air through the housing;
an air inlet, where air enters the blower and the impeller along the rotation axis of the impeller; and
an air outlet zone, where air exits the blower and the impeller in a direction perpendicular to the rotation axis of the impeller.

Preferably the impeller has at least one of:
an inner diameter, which is free of blades, preferably being in a range of 30 to 40 mm; and
an outer diameter, indicating a maximum radial extension of blades, preferably being in a range of 70 to 90 mm.

The blades of the impeller are preferably chosen to meet at least one of these conditions:
a number of blades in a range of 13 to 21, preferably 17 to 19;
a height of at least one blade at the air outlet zone in a range of 3 to 6 mm;
a blade inlet angel in a range of 25 to 45 degrees; and
a blade profile wrap angel in a range of 50 to 70 degrees.

The housing is preferably chosen to meet at least one of these conditions:
an air outlet zone having a height being in a range of 4 to 6 mm; and
having a clearance between the impeller and a top of the housing or a bottom of the housing chosen:
   in an axial direction in a range of 1 to 2 mm; and/or
   in a radial direction in a range of 0.5 to 2 mm.

According to some embodiments of the present disclosure, the noise of the blower can be greatly reduced, and the structure is simple and thus can be easily manufactured.

### BRIEF DESCRIPTION OF THE DRAWINGS

The principles, characteristics and advantages of the present disclosure can be better understood by describing the disclosure in more detail with reference to the accompanying drawings, in which:

FIG. 1 shows a perspective view of a centrifugal blower for a vehicle seat ventilation system according to an exemplary embodiment of the disclosure.

FIG. 2 shows a sectional view of the blower shown in FIG. 1.

FIG. 3 separately shows a perspective view of an impeller according to an exemplary embodiment of the disclosure.

FIG. 4 separately shows a perspective view of a shroud of the impeller shown in FIG. 3.

FIG. 5 shows a perspective view of a combination of blades and a hub of the impeller shown in FIG. 3.

FIG. 6 shows a partially enlarged perspective view of an inner side, i.e. the side facing the blades, of the shroud shown in FIG. 4.

FIG. 7 shows a partially enlarged perspective view of the combination shown in FIG. 5.

FIG. 8 shows a partially enlarged perspective view of a shroud that has been welded on blades, in which case a corresponding welding pit is formed at an outer side of the shroud.

FIG. 9 shows a perspective view of an impeller according to another exemplary embodiment of the disclosure.

FIG. 10 shows a partially enlarged perspective view of the impeller shown in FIG. 9.

### DETAILED DESCRIPTION OF EMBODIMENTS

For a clearer understanding of the technical problem to be solved, technical solutions and advantageous technical effects of the present disclosure, the disclosure will be further elaborated in conjunction with the drawings and a number of exemplary embodiments. It is to be understood that the specific embodiments described herein are only for the purpose of explaining the disclosure, rather than limiting the scope of the disclosure. The scope of the present disclosure is limited only by the claims.

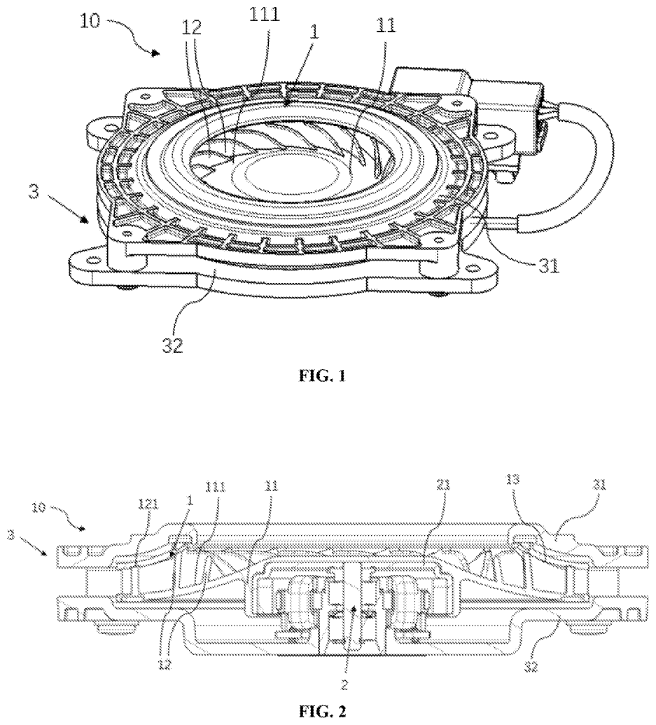

FIG. 1 shows a perspective view of a centrifugal blower for a vehicle seat ventilation system according to an exemplary embodiment of the disclosure.

FIG. 2 Shows a Sectional View of the Blower Shown in FIG. 1.

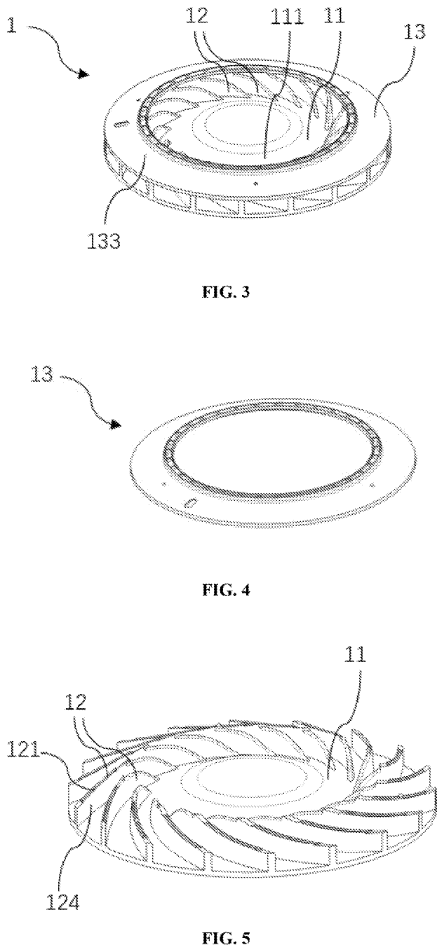

FIG. 3 separately shows a perspective view of an impeller according to an exemplary embodiment of the disclosure.

FIG. 4 separately shows a perspective view of a shroud of the impeller shown in FIG. 3.

FIG. 5 shows a perspective view of a combination of blades and a hub of the impeller shown in FIG. 3.

First, according to a first aspect of the disclosure, an impeller 1 for a centrifugal blower 10 of a vehicle seat ventilation system is provided, comprising: a hub 11; a plurality of blades 12 protruding from an end face 111 on one side of the hub 11, the blade 12 being configured in such a manner that when viewed in an axial direction towards the end face 111, a profile of a first cross section of the blade 12 axially farther from the end face 111 at least partially exceeds a profile of a second cross section of the blade axially closer to the end face 111; and an annular shroud 13 which is connected, facing the end face 111, to an edge 121, i.e. the upper edge shown in FIGS. 1-3 and 5, of the blades 12, wherein the blades 12 are integrally molded with the hub 11.

It can be seen from FIG. 5 that the blades 12 are integrally formed with the hub 11, which greatly simplifies the manufacture and assembly, and can reduce costs correspondingly.

Those skilled in the art can understand that the centrifugal blower 10 for a vehicle seat ventilation system is flat, and it may also be referred to as a radial blower. Gas enters from a central opening and exits from an outer periphery to the outside. The hub 11 is coupled to an output part of a drive motor 2 and is thus driven to rotate. As an exemplary embodiment of the disclosure, a recess is provided in the center of one side of the hub 11 facing away from the blades 12, and the recess is used for cooperating, such as in an insertable manner, with the output part of the drive motor 2. In particular, the drive motor 2 is configured as an external rotor motor, and the hub 11 is directly sleeved onto a rotor 21 of the drive motor 2 by means of its recess. This arrangement can greatly reduce the axial size of the blower and make the structure very compact.

Also, it can be seen from FIG. 1 and FIG. 2 that the blower 10 further comprises a housing 3 at least for covering the rotating impeller 1. Here, the housing 3 comprises an upper housing 31 and a lower housing 32, wherein the upper housing 31 covers the impeller 1 from the side of the blades 12, and the lower housing 32 covers the impeller 1 from the side of the drive motor 2. The lower housing 32 further covers at least a part of the drive motor 2. Here, it should also be pointed out that although positional terms “upper” and “lower” are used, they are used only in the cases of FIG. 1 and FIG. 2, rather than indicating the orientation of the blower 10 in any states of use.

The upper housing 31 and the lower housing 32 may be fixed to each other by bolts. In an assembled state, the impeller 1 is kept at a certain distance from the upper housing 31 and from the lower housing 32 without touching them, preventing any influence on the rotation of the impeller 1. The upper housing 31 and the lower housing 32 may be injection molded. In particular, the lower housing 32 may also be provided with mounting holes for fixing the blower 10 to a mounting position, for example, to a corresponding structure in a vehicle seat.

Since the centrifugal blower 10 of the vehicle seat ventilation system is generally flat and relatively small in size, the size of the blades 12 is also relatively limited. In this case, from an aerodynamic point of view, the difference in the configuration (type) of the blades 12 may have little influence on the aerodynamic performance, so usually manufacture factors are primarily considered for the configuration of blades 12.

However, because of its special application scenario, the vehicle seat ventilation system is used in the cabin of the vehicle, so it is not enough to simply ensure that the aerodynamic performance is free of influence, the user experience is also a very important aspect. To this end, the blade 12 is configured in such a manner that when viewed in an axial direction towards the end face 111, a profile of a first cross section of the blade 12 axially farther from the end face 111 at least partially exceeds a profile of a second cross section of the blade 12 axially closer to the end face 111. This means that the blade 12 is “three-dimensional”, in other words, it has a certain degree of inclination or torsion or twisting when viewed in the axial direction.

Those skilled in the art can understand that, as the profile of the first cross section at least partially exceeds the profile of the second cross section, it is impossible to mold blades 12 of such a configuration by a simple axial demolding process. However, the inventor has found that blades 12 of this configuration are very excellent in terms of acoustic performance and are capable of greatly reducing the operating noise, in particular in the case of longer blades 12 (for example, a backward impeller).

Under the premise of “three-dimensional” blades, the specific configuration of the blades can be determined as a function of factors such as the specific configuration, specific performance requirements, specific dimensions, etc. of the blower 10. The present disclosure does not impose any specific limitations on it or describe in detail.

According to an exemplary embodiment of the disclosure, the shroud 13 is integrally molded. This is also very advantageous for the manufacturing process. The shroud 13 may be a plastic part, and for this reason the shroud 13 is integrally injection molded.

The blades 12 and the hub 11 may also be made of plastic, and for this reason the blades 12 are integrally injection molded with the hub 11.

As mentioned above, this type of blades 12 cannot be manufactured by an axial demolding process. For this reason, according to an exemplary embodiment of the disclosure, the blades 12 are integrally molded with the hub 11 by a slider injection molding process.

In order to avoid complicating the mold of injection molding caused by a complicated structure or even failure of injection molding, according to an exemplary embodiment of the disclosure, the shroud 13 is connected to the blades 12 by a subsequent assembly process. Preferably, the shroud 13 is connected to the edges 121 of the blades 12 by welding, in particular by ultrasonic welding.

For a more controllable welding process, according to an exemplary embodiment of the disclosure, the shroud 13 and corresponding blades 12 are formed with welding assistance structures which can be engaged with each other. The “welding assistance structure”, as the name implies, helps to form desired welding beads, for example, it can help to control the flow of molten materials.

Obviously, only when the shroud 13 and the blades 12 are accurately positioned relative to each other during welding, can a desired gas flow path be formed on the impeller 1. To this end, the shroud 13 and the corresponding blades 12 are formed with positioning structures which can be inserted into each other. Through an axial inserting action, the shroud 13 can be held on the blades 12 in a relatively stable position, without any displacement during the welding process.

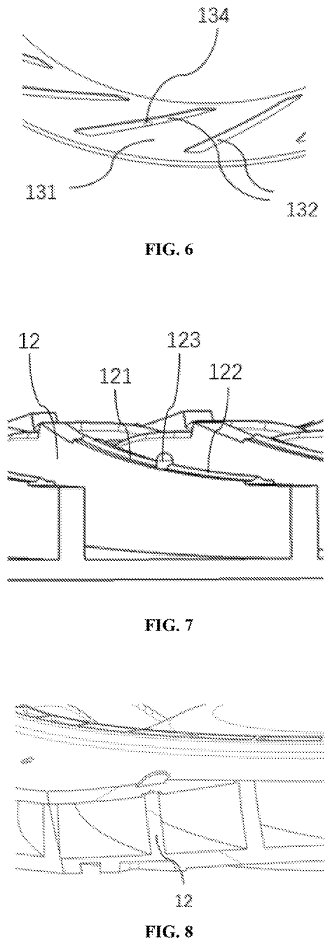

FIG. 6 shows a partially enlarged perspective view of an inner side, i.e. the side facing the blades 12, of the shroud 13 shown in FIG. 4.

FIG. 7 shows a partially enlarged perspective view of the combination shown in FIG. 5.

FIG. 8 shows a partially enlarged perspective view of a shroud 13 that has been welded on blades 12, in which case a corresponding welding pit is formed on an outer side 133 of the shroud 13.

In particular, as shown in FIGS. 6, 7 and 8, the welding assistance structures comprise a boss 122 formed on the edge 121 and a groove 132 formed at an inner side 131 of the shroud 13 for receiving the boss 122, and the shroud 13 can be welded to the corresponding blades 12 by applying ultrasonic waves from the outer side 133, i.e. the upper side in FIG. 3, of the shroud 13 to an area of the boss 122. The groove 132 has a bottom, which means it does not penetrate through the shroud 13.

The boss 122 may be in the shape of a ridge that is high in the middle and low on both sides, which can be seen clearly from FIG. 7. Of course, those skilled in the art can understand that the present disclosure is not limited thereto, and any suitable shapes are possible. In addition, the boss 122 may also be formed at only a portion of the upper edge 121 of the blade 12, for example, only at a central section, and the portions on both ends are not formed with the boss 122, which can be seen from FIG. 5 and FIG. 7.

It can also be seen from FIGS. 6, 7 and 8 that, according to an exemplary embodiment of the disclosure, the positioning structures comprise a positioning pin 123 formed on the edge 121 and a positioning hole 134 formed at the inner side 131 of the shroud 13 for receiving the positioning pin 123. As shown in FIG. 4, the positioning hole 134 may be a through hole penetrating through the shroud 13.

In particular as shown in FIG. 7, according to an exemplary embodiment of the disclosure, the positioning pin 123 is located at the boss 122, and the positioning hole 134 is located at the groove 132. The positioning pin 123 can be melted during welding and thus be welded to the shroud 13 in a corresponding area.

It is to be understood that both the welding assistance structures and the positioning structures are formed all together with the molding process of the blades 12 and the shroud 13, and no additional processing step is required.

Since the shroud 13 here acts as a boundary, i.e. the upper boundary in the drawing, of a gas flow channel, the shroud 13 needs to be reliably connected to the edge 121 of each blade 12, which means it is sealed in the connection area. For this reason, as shown in FIG. 5, each blade 12 is formed with the boss 122. Of course, grooves 132 are provided in corresponding areas on the shroud 13. Those skilled in the art can understand that the positioning structures only play the role of pre-positioning, and in principle, only a limited number of positioning points are required to enable reliable pre-positioning. Theoretically speaking, it takes only two positioning points to achieve relatively stable pre-positioning in both radial and circumferential directions. To this end, only some of the blades 12 are formed with the positioning pins 123. Certainly, the positioning holes 134 are also formed in the corresponding areas of the shroud 13. It can be seen from FIG. 4 and FIG. 5 that a total of three positioning pins 123 and three corresponding positioning holes 134 are provided, which are evenly spaced and distributed in the circumferential direction.

According to an exemplary embodiment of the disclosure, the impeller 1 is configured as a backward impeller. Qualitatively speaking, “backward” means that each blade of the impeller extends against a direction of rotation during operation from a front edge, i.e. the radially inner edge, to a trailing edge, i.e. the radially outer edge, and “forward” is exactly on the contrary. Such definitions are known in the art and will not be repeated here.

It is to be understood that the blade has a pressure surface and a suction surface opposite thereto. During operation, air flows from the front edge along the suction surface to the trailing edge, usually generating vortexes, which continuously form, fall off, split, and disappear at the suction surface and propagate in the form of noise, resulting in huge vortex noise. This is the same for both forward and backward impellers. Of course, “three-dimensional” blades can reduce the generation of vortexes to a certain extent, but obviously it is beneficial to further reduce it. Therefore, the structures described below in conjunction with other embodiments are also applicable to the above embodiments, as long as they do not technically conflict with each other.

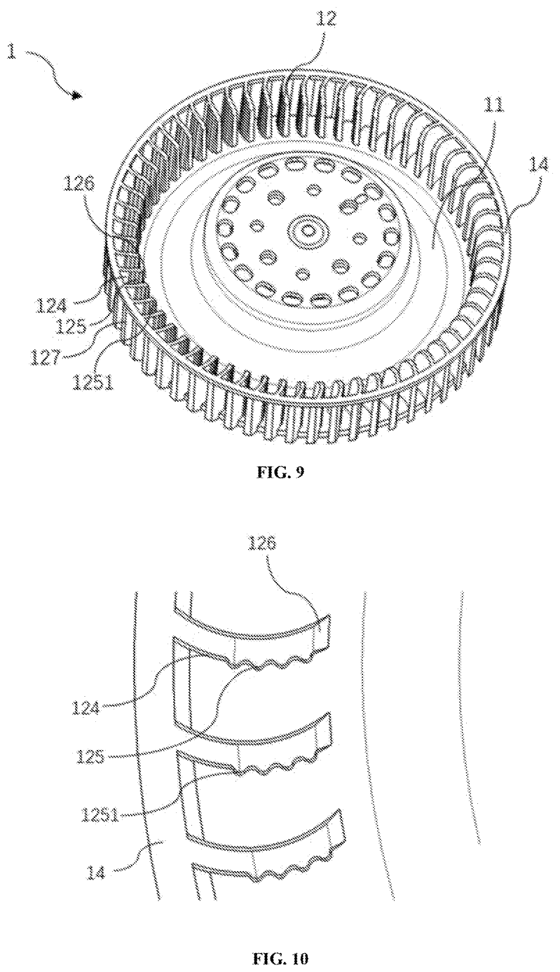

FIG. 9 shows a perspective view of an impeller according to another exemplary embodiment of the disclosure. Different from the impellers shown in the above drawings, this impeller is a forward impeller.

FIG. 10 shows a partially enlarged perspective view of the impeller shown in FIG. 9.

To this end, according to an exemplary embodiment of the disclosure, as shown in FIG. 9 and FIG. 10, a protruding vortex reducing structure 125 is formed on a suction surface 124 of the blade 12. The “protruding” structure can block, limit, or destroy the noisemaking vortex gradually generated along the suction surface 124. For this reason, according to a second aspect of the disclosure, another impeller 1 for a centrifugal blower 10 of a vehicle seat ventilation system is provided, comprising: a hub 11 and a plurality of blades 12 arranged on one side of the hub 11, wherein a suction surface 124 of the blade 12 is formed with a protruding vortex reducing structure 125.

As mentioned above, the vortex is gradually formed as it flows from the front edge 126 of the blade 12 along the suction surface 124 to the trailing edge 127. Therefore, according to an exemplary embodiment of the disclosure, the vortex reducing structure 125 is arranged adjacent to the front edge 126 of the blade 12, which can destroy the formation of vortex at its early stage so as to destroy the vortex formation to the greatest extent.

As shown in FIG. 9 and FIG. 10, the vortex reducing structure 125 comprises at least one rib 1251, which extends not in parallel to a direction of extending of the suction surface 124 of the blade 12 from the front edge 126 to the trailing edge 127, in other words, the rib 1251 does not extend following a flow direction of the gas on the suction surface 124, and as a result, the gas flow can be effectively blocked.

According to an exemplary embodiment of the disclosure, as shown in FIG. 10, the at least one rib 1251 comprises a plurality of ribs arranged in parallel to and spaced apart from one another so that the vortex reducing structure 125 is wave-like.

In particular, as shown in FIG. 10, according to an exemplary embodiment of the disclosure, the rib 1251 extends axially. In particular, the rib 1251 has a constant cross section in the axial direction. This enables the vortex reducing structure 125 to be configured to allow to be molded by axial demolding. The rib 1251 having a constant cross section may be molded by axial demolding, but the rib 1251 that can be molded by axial demolding does not necessarily have a constant cross section, which means, for example, it may have a certain demolding angle which makes the cross section no longer constant. This can be fully understood by those skilled in the art, and no more description will be given here.

According to an exemplary embodiment of the disclosure, as shown in FIG. 10, the vortex reducing structure 125 is arranged at least over half a length of the blade 12. This can effectively destroy the formation of larger vortexes.

Those skilled in the art can understand that although the vortex reducing structure 125 is described above with reference to the forward impeller shown in FIG. 9 and FIG. 10, obviously the vortex reducing structure 125 may also be applied to a backward impeller. No more details will be given here.

Theoretically speaking, the fact that the vortex reducing structure 125 per se can be molded by axial demolding does not mean that the blade 12 formed with the vortex reducing structure 125 can also be molded by axial demolding. For this reason, the blade 12 is preferably configured to allow to be molded by axial demolding. This facilitates the formation of blades 12.

As shown in FIG. 9 and FIG. 10, the blades of the forward impeller are relatively short in length, so “one-dimensional” blades may also be used, which in combination with the vortex reducing structures 125 can as well significantly reduce the noise generated by vortexes. Here, the so-called “one-dimensional” may mean that the blades allow to be molded by axial demolding.

As shown in FIG. 9 and FIG. 10, according to an exemplary embodiment of the disclosure, the impeller 1 may further comprise a reinforcing ring 14 arranged along outer peripheral edges of the blades 12 on a side away from the hub 11 and connected to the blades 12. Here, the reinforcing ring 14 is mainly used for strength reinforcement, and as its function differs from the aforementioned shroud 13, it has a relatively narrow structure. In principle, in the case of a forward impeller, the reinforcing ring 14 may also be omitted, as long as the blades 12 have sufficient strength.

According to an exemplary embodiment of the disclosure, the reinforcing ring 14 is integrally molded with the blades 12.

For the embodiments shown in FIG. 9 and FIG. 10, the hub 11, the blades 12 and the reinforcing ring 14 may be integrally molded.

It can be seen from the above description that although “three-dimensional” blades are the most advantageous for the backward impeller, in principle, their use in a forward impeller is not excluded. Similarly, although the vortex reducing structure is more suitable for being used in conjunction with and formed with “one-dimensional” blades, its use in a backward impeller is not excluded. And all these should be construed only in terms of technical feasibility.

According to a third aspect of the disclosure, a centrifugal blower 10 for a vehicle seat ventilation system is provided, the blower 10 comprising the impeller 1 according to any one of the above embodiments.

According to a fourth aspect of the disclosure, a vehicle seat ventilation system is provided, which comprises the impeller 1 according to any of the above embodiments or the blower 10 according to any one of the above embodiments.

While specific embodiments of the disclosure have been described in detail here, they are for the purpose of explanation only and should not be construed as limitations on the scope of the disclosure. Various substitutions, changes and modifications can be devised without departing from the spirit and scope of the disclosure.

1. An impeller for a centrifugal blower of a vehicle seat ventilation system, comprising:
a hub; and
a plurality of blades arranged on one side of the hub.

2. The impeller according to claim 1, wherein a suction surface of the blade is formed with a protruding vortex reducing structure

3. The impeller according to claim 1, wherein the impeller has at least one of:
an inner diameter, which is free of blades, preferably being in a range of 30 to 40 mm;
an outer diameter, indicating a maximum radial extension of blades, preferably being in a range of 70 to 90 mm;
a number of blades in a range of 13 to 21, preferably 17 to 19;
a height of at least one blade at an air outlet zone in a range of 3 to 6 mm;
a blade inlet angel in a range of 25 to 45 degrees; and
a blade profile wrap angel in a range of 50 to 70 degrees.

4. The impeller according to claim 1, wherein
the vortex reducing structure is configured to allow to be molded by axial demolding.

5. The impeller according to claim 1, wherein
the blades are configured to allow to be molded by axial demolding.

6. The impeller according to claim 1, wherein
the blades are integrally molded with the hub.

7. The impeller according to claim 6, wherein the blades are integrally injection molded with the hub.

8. The impeller according to claim 1, wherein
the impeller is configured as a forward impeller.

9. The impeller according to claim 8, wherein the impeller further comprises a reinforcing ring arranged along outer peripheral edges of the blades on a side away from the hub and connected to the blades.

10. The impeller according to claim 9, wherein the reinforcing ring is integrally molded with the blades.

11. The impeller according to claim 1, wherein
the vortex reducing structure is arranged adjacent to a front edge of the blade; and/or
the vortex reducing structure comprises at least one rib, which extends not in parallel to a direction of extending of the suction surface of the blade from the front edge to a trailing edge of the blade

12. The impeller, according to claim 11, wherein the at least one rib comprises a plurality of ribs arranged in parallel to and spaced apart from one another so that the vortex reducing structure is wave-like; and/or the rib extends axially; and/or
the vortex reducing structure is arranged at least over half a length of the blade;
and/or
the rib extends across an entire height of the blade.

13. The impeller according to claim 1, wherein
the impeller is configured as a backward impeller.

14. The impeller according to claim 13, wherein the blade is configured in such a manner that when viewed in an axial direction towards an end face of the hub-facing the blade, a profile of a first cross section of the blade axially farther from the end face at least partially exceeds a profile of a second cross section of the blade axially closer to the end face; and
the impeller further comprises an annular shroud which is connected, facing the hub, to an edge of the blades.

15. The impeller according to claim 14, wherein the shroud is integrally injection molded, and the shroud is connected to the edge by welding.

16. A centrifugal blower for a vehicle seat ventilation system, the blower comprising the impeller according to claim 1.

17. The centrifugal blower according to claim 16, wherein a housing of the centrifugal blower is chosen to meet at least one of these conditions:
an air outlet zone having a height being in a range of 4 to 6 mm; and
having a clearance between the impeller and a top of the housing or a bottom of the housing chosen:
in an axial direction in a range of 1 to 2 mm; and/or
in a radial direction in a range of 0.5 to 2 mm.

18. A vehicle seat ventilation system, which comprises the impeller according to claim 1.

19. The impeller according to claim 2, wherein
the vortex reducing structure is configured to allow to be molded by axial demolding.

20. The impeller according to claim 3, wherein
the vortex reducing structure is configured to allow to be molded by axial demolding.
